(19) United States
(12) Patent Application Publication
(10) Pub. No.: US 2002/0184316 A1
(43) Pub. Date: Dec. 5, 2002

(54) System and method for MAPI client server communication

(76) Inventors: Huw K. Thomas, New York, NY (US); Ziad N. Saval, River Edge, NJ (US)

Correspondence Address: TESTA, HURWITZ & THIBEAULT, LLP, HIGH STREET TOWER, 125 HIGH STREET, BOSTON, MA, 02110, US

(21) Appl. No.: 09/836,904

(22) Filed: Apr. 17, 2001

(51) Int. Cl. G06F 15/16

(52) U.S. Cl. 709/206

(57) ABSTRACT

An extension for extending a client application for operation with a server across a network having a gateway or firewall includes an interface for integrating with the client application, and a communication initiator for repeatedly causing the client to initiate a communications session with the server, such that the communications session allows for communication between the client and the server.

### TECHNICAL FIELD

This invention relates to computer communications and, more particularly, to communications of clients and servers using such protocols as the Messaging Application Programming Interface (MAPI).

### BACKGROUND INFORMATION

Internet Protocol (IP) is a transport layer protocol that is in wide use in the Internet and other communications networks, typically in conjunction with transport layer protocols such as Transmission Control Protocol (TCP) and/or User Datagram Protocol (UDP). A node on a network using IP typically has one or more unique assigned IP addresses. TCP and UDP each associate virtual ports with each IP address. TCP/IP and UDP/IP data packet header information includes the address and port of packet's source, and the address and port of the packet's destination. The addresses typically identify a node on the network, and one or more ports are typically associated with each of the node's network-accessing software applications.

Network Address Translation (NAT) is a technology that is used to extend the number of available addresses. NAT is described in Internet Engineering Task Force (IETF) documents, for example in RFC 1631 and RFC 1597. RFC 1597 specifies private network addresses that are not assigned on the public Internet network. Organizations can assign the private IP addresses to nodes in their private network. NAT technology facilitates communication between nodes on such a private network and the public Internet. Generally, NAT involves substitution of a globally registered (i.e. public) IP address into the source IP address part of an IP data packet leaving the private network, and substitution of the appropriate private IP address into the destination part of a message entering the private network. This substitution is typically performed by a network node that is located topologically between a private network and a public network, for example, by a network node that is functioning as a gateway between the private network and the public network. This gateway may be a firewall.

TABLE 1
NAT EXAMPLE

| Node Name | Private IP Address | Public IP Address |
|---|---|---|
| c12 | 192.168.16.12 | 38.116.73.1 |
| c26 | 192.168.16.26 | 38.116.73.2 |
| c27 | 192.168.16.27 | 38.116.73.3 |
| c59 | 192.168.16.59 | 38.116.73.4 |

As an example of NAT, consider the translation information in TABLE 1. A message originating at network node c12 has the IP address 192.168.16.12 in the source IP address part of the header of its data packets, because node c12 is configured such that 192.168.16.12 is its IP address. If the packet is destined for the public network, it passes through the NAT gateway on its way to the public network, and the NAT gateway substitutes the IP address 38.116.73.1 into the part of the packet header that indicates the source IP address. The NAT gateway also recalculates various message checksums, as appropriate. The packet is then forwarded to the destination host in the public network as though it originated from the public address assigned by the NAT gateway. When a data packet arrives at the NAT gateway from the public network addressed to the substituted public address (in this example, 38.116.73.1), the private IP Address of c12 (192.168.16.12) is substituted for the public IP address 38.116.73.1 by the NAT gateway in the destination part of the packet header, checksums are recalculated as appropriate, and the packet communicated into the private network for delivery to node c12.

One benefit of NAT is that it hides the private network's configuration from the public network, thereby making the private network more secure. NAT also enables private network access to the public network using a much smaller number of public IP addresses than number of nodes in the private network. In the above example, even though the four workstations are spread across a wide section (0.12 through 0.59) of the RFC 1597 Class C private network (192.168.16), the public IP addresses have been consolidated into a very small range of public addresses (0.1 through 0.4 of network 38.116.73).

A disadvantage of NAT is that a data packet sent from a node in a private network does not arrive at its destination with the source address matching the actual IP address of the node that sent the message. NAT gateways generally are designed to perform substitution and forwarding in a transparent manner, however, it is sometimes difficult for a NAT gateway to handle the substitution transparently. The NAT gateway may be unable to associate inbound messages with the correct node in the private network after some delay since the last communication, particularly if public addresses are assigned dynamically and temporarily to the nodes in the private network, so that a public IP address associated with a particular node in the private network changes over time. A gateway can be configured look for specific protocols or applications, and perform the appropriate substitutions, but if a protocol about which the NAT gateway is unaware includes the IP address in a location other than the IP packet header source and destination address fields, such as in the message portion of an IP packet, the NAT gateway typically will not perform appropriate substitution.

Port address translation (PAT) is a variation of NAT that can map multiple private network nodes to a single public IP address. The single public address replaces the private network addresses of the private network nodes in outgoing Internet sessions. Different ports (e.g. TCP or UDP ports) on the public network interface of the PAT gateway are assigned to each communication session.

TABLE 2
PAT EXAMPLE

| Node Name | Private IP Address | Public Address:Port |
|---|---|---|
| c12 | 192.168.16.12 | 38.116.73.1:1028 |
| c26 | 192.168.16.26 | 38.116.73.1:1029 |
| c27 | 192.168.16.27 | 38.116.73.1:1030 |
| c59 | 192.168.16.59 | 38.116.73.1:1031 |

As shown in the PAT example of TABLE 2, the four network nodes c12, c26, c27, and c59 have the respective private network IP addresses 192.168.16.12, 192.168.16.26, 192.168.16.27, and 192.168.16.59 as in the example of TABLE 1. These addresses are mapped to the single public network address 38.116.73.1. In this example, when c12 initiates a communication session with a node in the public network, node c12's communication session is mapped to port 1028. When node c26 initiates a communication session with a node in the public network, node c26 is mapped to port 1029. Although not shown in the table, if node c12 initiates another communication session with the same or different node on the public network, another port on the public network interface might be assigned to that session.

PAT has the advantage of further reducing the number of public IP addresses required by the private network to as few as one public IP address. On the other hand, in addition to the disadvantages described with NAT above, PAT makes it even more difficult for a public network node to initiate a communication session with a node in the private network. Without pre-configuration, the PAT gateway would not know which node to forward an inbound message coming into an unassigned port. Although this might be considered an advantage, in that the PAT gateway acts as security barrier that prevents outside intrusion into the network, this behavior can prevent proper operation of an application that requires a system on the public network to initiate a communications session. It may be possible, with special pre-configuration, to have the PAT gateway send messages received at a specific ports to specific internal network nodes. As mentioned above, a gateway that is aware of specific applications and protocols may be able to determine that a particular inbound message is part of a particular protocol and modify or forward it accordingly, but these solutions require pre-configuration of the ports, applications, and protocols involved, and additional computation by the NAT or PAT gateway.

In general, in addition to the mapping issues that occur with NAT and PAT, a gateway that is a firewall might be configured, deliberately or inadvertently, not to forward certain types of data packets. A firewall is typically configured to restrict the types of communications that can be initiated between the networks it sits between, typically a private and public network. Thus, in addition to, or instead of, the problems that nodes in a public network -may have in initiating communications sessions with nodes in a private network due to use of NAT and/or PAT, a firewall or other gateway may deliberately can be configured to prevent a node in a public network from initiating communication with a node in the private network.

A system administrator can “open” ports in a firewall, to allow communications through. As a simple example, if a particular application's communication protocol uses port 23 to communicate, and the network administrator wants to allow use of that application, the system administrator typically can configure the firewall to allow communications using port 23. Depending on the network administrator's security priorities, opening ports to allow communications may not be an acceptable solution.

One example of a protocol used to communicate electronic mail, also referred to as email, between electronic mail clients and electronic mail servers is version 3 of Post Office Protocol (POP3). POP3 is used by electronic mail clients to communicate with electronic mail servers. POP3 requires that the POP3 electronic mail client poll the POP3 server to check for electronic mail. A POP3 client periodically initiates a communications session with a POP3 server, and in that communications session the POP3 client makes requests of the POP3 server. One such request would be information regarding new electronic mail messages; the POP3 server, in response to a POP3 client's request, provides information regarding any new electronic mail messages. The POP3 client can request the messages as part of the same communications session or as part of a different session that the POP3 client initiates at a later time. Examples of clients that operate using the POP3 protocol are EUDORA PRO from Qualcomm, Inc., and NETSCAPE MESSENGER from Netscape Communications Corporation.

Generally, POP3 clients are not affected by the use of NAT, even if the POP3 client is in a private network and the POP3 server is in the public network, because a POP3 client in a private network initiates a communications session with a POP3 server, and a NAT gateway generally is able to effectively perform the appropriate IP address substitutions to allow a communication session initiated by a POP3 client to take place.

### SUMMARY OF THE INVENTION

Servers and clients can have difficulty communicating across firewalls and gateways, particularly if the firewalls and gateways use network address translation (NAT) or port address translation (PAT), or have are configured to prevent communication of certain types of packets. In an embodiment of the invention, an extension to a client software application is provided that can enable use of the client with a server across a network that includes such a firewall or gateway. The extension extends the functionality of the client by causing the client to initiate a communications session with the server. The client is able to initiate such communication, even in network configurations in which the server would be unable to initiate communications with the client, such as if NAT, PAT, or firewall blocking is in place. Once the communication is initiated by the client, the server and the client can communicate, and the server can notify the client of new events. For example, the server can be an electronic mail server, the client can be an electronic mail client, and the event can be the arrival of new electronic mail.

In general, in one aspect, the invention relates to an extension for extending a Messaging Application Programming Interface (MAPI) client for operation with a MAPI server across a network. The extension includes an interface for integrating with the MAPI client. (The term extension is used broadly here to include any sort of addition to a client.) The extension also includes a communication initiator for causing the MAPI client to initiate a communications session between the MAPI client and the MAPI server. A communications session refers broadly to communicative interaction between two network nodes over the network. The communications session, once initiated by the MAPI client, allows for communication between the MAPI client and the MAPI server.

In general, in another aspect, the invention relates to a method for extending a MAPI client for operation with a MAPI server. An extension to the MAPI client is provided. The extension causes the MAPI client to initiate a communications session from the MAPI client to the MAPI server. The communications session allows for communication between the MAPI client and the MAPI server.

Various embodiments of the invention may include the following features. In one embodiment, the client is a MICROSOFT OFFICE software application, such as MICROSOFT OUTLOOK. In one embodiment, the server is MICROSOFT EXCHANGE. The MICROSOFT OFFICE, MICROSOFT OUTLOOK and the MICROSOFT EXCHANGE families of applications are all available from Microsoft Corporation of Redmond, Wash.

In various embodiments, the communication between the client and the server can include various types of messages, including without limitation the notification of new electronic mail messages, calendar items, task items, and information about such electronic mail, calendar, and task items (e.g. the actual communication of electronic mail messages, calendar items, and task items).

In one embodiment, the extension can initiate a communications session periodically, for example at a predetermined time interval. This can be implemented by including a timer in the extension. In such an embodiment, the extension can include a user interface for facilitating configuration of the predetermined time interval. In another embodiment, the extension can initiate the communications session upon the occurrence of an event, for example upon a particular mouse movement, or upon the selection of a menu item. In such an embodiment, the extension can include a user interface for facilitating configuration of the triggering event(s).

The network is typically an internet protocol (IP) network, but can be any sort of communications network. The network can include a gateway connecting a first network and a second network, for example a public network and a private network. The gateway can implement NAT, PAT, or both. The gateway can be a firewall. Generally, the gateway prevents communication initiation by servers in communication with the first network to clients in communication with the second network.

In general, in another aspect, the invention relates to an extension for extending an electronic mail client application running on a computer connected to a first network for operation with a electronic mail server running on a computer connected to a second network. The network includes a gateway connecting the first network and the second network; the gateway prevents notification of new electronic mail messages from the electronic mail server to the electronic mail client. The extension includes an electronic mail client application interface subsystem for integrating with the electronic mail client, and a communication initiation subsystem for causing the electronic mail client to initiate a communications session from the electronic mail client to the electronic mail server. The communications session allows for information relating to new electronic mail messages received at the server to be communicated from the electronic mail server to the electronic mail client.

The foregoing and other objects, aspects, features, and advantages of the invention will become more apparent from the following description and from the claims.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is schematic drawing of a client in communication with a server according to an embodiment of the invention.

FIG. 2 is a schematic drawing of a user interface display in a client incorporating an extension in an embodiment of the invention.

FIG. 3 is a schematic drawing of a client node including a client according to an embodiment of the invention.

FIG. 4 is a flowchart of a method according to an embodiment of the invention.

### DESCRIPTION

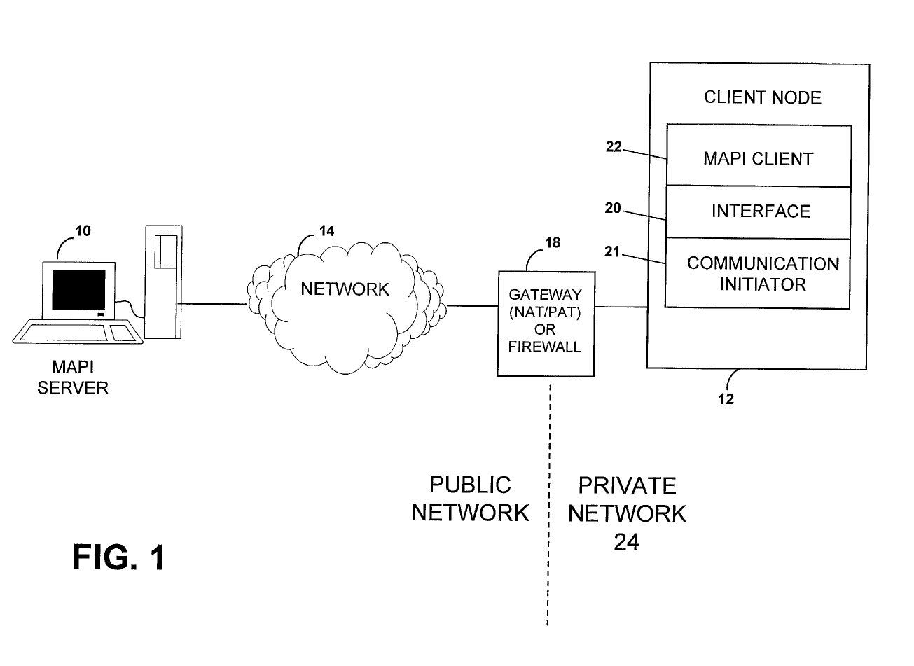

Referring to FIG. 1, a client node 12 communicates across gateway 18 and network 14 with a server 10. The client node 12 is a node on a first network 24 (which may be a private network) that connects via the gateway 18 to a second network 14 (which may be a public network). Preferably, both the first 24 and second 14 networks can communicate Internet Protocol (“IP”) packets.

A server 10 can be any sort of computer or device that can respond to requests made over a network and provide data according to the Messaging Application Programming Interface (MAPI) messaging architecture, which can be used by a client node 12 to access information on a server 10. Preferably, the server 10 is a server class computer with one or more processors running one or more MAPI server applications, such as MICROSOFT EXCHANGE.

A client node 12 can be implemented in any sort of computer or device with sufficient network communications capability to make requests from a server 10 using the MAPI messaging architecture. Typically, the client will be implemented as one or more MAPI client software applications, such as MICROSOFT OUTLOOK, running on a computer, such as a general purpose personal computer, laptop computer, personal digital assistant, digital telephone, and so on.

MAPI is a messaging architecture that enables multiple applications to interact with multiple messaging systems across a variety of hardware platforms. MAPI is built into the MICROSOFT WINDOWS family of operating systems; for example, it is a component of the MICROSOFT WINDOWS 95 operating system and MICROSOFT WINDOWS NT® operating system. MAPI is used by MICROSOFT OFFICE applications, and in particular by the MICROSOFT OUTLOOK email client, to access electronic mail on a MICROSOFT EXCHANGE electronic mail server.

MAPI is made up of a set of common application programming interfaces (“APIs”) and a dynamic-link library (“DLL”) component. The APIs can be used in programs to create and access diverse messaging applications and messaging systems, offering a uniform environment for development and use. The DLL's contain executable code to implement the function calls made via the APIs. The DLL component contains the MAPI subsystem, which manages the interaction between front-end messaging applications and back-end messaging systems and provides a common user interface for frequent tasks. The MAPI subsystem acts as a central clearinghouse to unify various messaging systems and shield clients from their differences.

The MAPI protocol, as implemented by MICROSOFT, and likely others, operates across a network such that a MAPI client does not poll a MAPI server. The MAPI client 22, typically a software application running on a client node 12, initially connects (i.e. “logs on”) to the MAPI server 10, to notify the MAPI server 10 that the MAPI client 22 is running. Once the MAPI server 10 is so notified, the MAPI server 10 initiates communications sessions with the MAPI client 22 to notify the MAPI client 22 when events take place. For example, in one implementation of MICROSOFT EXCHANGE, new mail notification messages are sent by means of UDP packets from the server 10 to the client 22. The ports used for this notification are set by the client 22 when the client 22 first logs on to the MAPI server 10. As part of the log on process, the MAPI client 22 communicates to the MAPI server 10 the network address and port where it expects to receive new mail notification messages. Typically, this will be a port in the 1024-65535 range. The MAPI server 10 uses the network address and port communicated in this message at the time of log on, and does not use the source network address in the IP packet header to determine the MAPI client's network address.

When the MAPI server 10 receives a mail message for a mailbox that a MAPI client 22 is logged on to, it sends a message to the network address and port communicated by the MAPI client logged on to that mailbox. Typically, this is a short message communicated in the form of a User Datagram Protocol (UDP) packet. Because the MAPI client 22 selects a receive port at startup, and the MAPI server 10 does not always use the same port to send the notification packet, there is no way to predict either the source or destination ports that the notification message will use. When the MAPI client 22 and the MAPI server 10 are located on the same network, or networks without barriers preventing communications from being initiated from the server 10 to the client 12 this implementation functions acceptably. The MAPI server 10 is able to initiate communications to the MAPI client 22 across the network using the IP address provided to it by the MAPI client 22, and whatever ports are selected by the MAPI server 10 and the MAPI client 22.

Some other network topologies are not as successful, however. In the network of FIG. 1, for example, the MAPI client 22 and the MAPI server 10 are separated by one or more gateway or firewall 18. The gateway or firewall 18 may be a NAT and/or PAT gateway (referred to generally as a NAT/PAT gateway to mean a gateway implementing NAT, PAT, or some combination) or other network device that modifies the IP address of packets as they are communicated to the public network 14 or that prevents communication of certain packets (such as the UDP packets from the MAPI server to the MAPI client). With such a gateway 18 between the MAPI server node 10 and the MAPI client node 12, the MAPI server 10 may be unable to notify the MAPI client 22 of certain events, such as the arrival of mail.

For example, if the MAPI client 22 is in a private network that uses NAT or PAT, for example, the MAPI client 22 will initially communicate to the MAPI server 10 the MAPI client's private network IP address, not the public network IP address substituted for the private network IP address by a NAT/PAT gateway 18. This is because the IP address is communicated in the message portion of the data packet, and the NAT/PAT gateway 18, if unaware of the MAPI protocol, substitutes network addresses that are in the packet header, not in the packet data. If the MAPI server tries to use the private network IP address to initiate communications with the MAPI client, the MAPI server's attempt to initiate communications to the MAPI client will fail, because the private network IP address will not be recognized by the public network.

Even if a gateway 18 does not implement NAT or PAT, it is possible for the gateway 18, if it is a firewall, for example, to prevent communications initiated from the public network to the private network. Such a gateway or firewall 18 will prevent communications initiated by a MAPI server 10, even using a correct address, and so prevent a MAPI server 10 from notifying the MAPI client 22 of events. As one example, this would prevent a MAPI electronic mail server 10 from notifying a MAPI electronic mail client 22 of the arrival of new electronic mail.

It is frequently possible, however, for a MAPI client 22 to communicate with a MAPI server 10 across such a NAT/PAT gateway or firewall 18 if the MAPI client 22 initiates a communication session with the MAPI server 10. Although this is not the typical operation of MAPI clients, if a communications session is initiated by the MAPI client 22 to the MAPI server 10, that communications session can be used by the MAPI server 10 to inform the MAPI client 22 of new events. If a communications session is initiated by the MAPI client, a MAPI server will use the IP address in the packet header to communicate with that MAPI client for the duration of that session. The MAPI server can use that communications session, once initiated by the MAPI client, to provide the MAPI client with updated event information. The updated event information, could include, as one example, information about new electronic mail messages received by the server for the MAPI client 22. This information could include, as other examples not intended to be limiting, the new electronic mail messages, calendar items and updates, task items and updates, information about such calendar and task updates, or some combination.

A communications session between the MAPI client 22 and the MAPI server 10 can be initiated by the MAPI client 22 at a periodic interval, for example every thirty seconds, every minute, five minutes, ten minutes, or other appropriate period for that MAPI client and network. In many networks, a period of thirty seconds or longer appears to strike an appropriate balance between MAPI client and network bandwidth usage and apparent responsiveness of the MAPI client to the user. A communications session between the MAPI client 22 and the MAPI server 10 can be initiated by invoking an instance of a MAPI method that causes the MAPI client to initiate a communications session to the MAPI server 10.

Alternatively, a communications session between the MAPI client 22 and the MAPI server 10 can be initiated by the MAPI client 22 in response to an event. As a few examples of such events, not intended to be limiting, are the mouse moving over a particular area of the screen, the mouse moving more than a predetermined distance, the user initiating a print or other menu command, or the user using a toolbar item. Upon occurrence of these or other events, a communications session between the MAPI client 22 and the MAPI server 10 can be initiated.

In one embodiment, an extension for extending a client 22 for operation with a server 10 across a network 14 including a gateway 18 implementing NAT or PAT (i.e. a NAT/PAT gateway), or otherwise blocking access between the server 10 and the client 22, includes an interface 20 for integrating with the client 22 and a communication initiator 21 for periodically initiating a communications session by the client 22 to the MAPI server 10. Here, the term extension is used to denote a module that is added to the client to extend the functionality of the client. The extension can be a software module or some combination of hardware and software. Generally, a client may provide some capability or mechanism for extensions to be incorporated, but an extension does not necessarily have to make use of such capability or mechanism, and may be added in some other way.

In one embodiment, the extension is implemented as an add-in to a MAPI client 22. MICROSOFT OFFICE applications, for example, are provided with a capability of having extensions added. One such application, MICROSOFT OUTLOOK, which is an example of a MAPI client with which an embodiment of the invention may be used, can incorporate custom object model (“COM”) add-ins (also referred to as add-ons in earlier versions of OUTLOOK). These add-ins can be implemented in the form of DLL files. In one embodiment, a software module coded in Visual Basic is compiled into a DLL file that provides the interface 20 and the communication initiator 21 as an extension to the MAPI client 22. The DLL code is invoked by a MAPI client 22 such as OUTLOOK in response to certain events, such as start-up of the OUTLOOK application.

In one embodiment, an extension in the form of a DLL file includes code place a custom button on an icon bar and in the drop-down list of the main menu. When the custom button is pressed by the user, the extension code is notified of the event and can perform actions in response to it. For example, in response to a button or mouse-click event, a dialog box is presented to allow the user to configure the communication initiator 21. The configuration settings are stored in the operating system registry and thus preserved when the user restarts OUTLOOK. Should the user elect to enable the communication initiator 21, a timer object is created and the “alarm state” of the timer is set for the user-configured interval. When the timer trips, the communication initiator 21 is called and a dialog is initiated with the MAPI server 10.

The particular implementation of an extension will vary depending on the MAPI client. An overview of an OUTLOOK 2000 and an OUTLOOK 98 implementation is presented to show exemplary embodiments. Other embodiments with other MAPI clients 22 may be implemented in a similar manner. The scope of the invention is not intended to be limited to the OUTLOOK add-ins described in detail herein.

In one embodiment of an add-in to OUTLOOK 2000, the add-in uses the component object model (COM) “IDTExtensibility2” interface with the “Startup” option to attach to the client 22. This is an interface provided by the developer of the application (i.e. MICROSOFT) for the use of add-ins. The IDT_Extensibility2_OnConnection method includes the Application.ActiveExplorer.CommandBars method which is used to add the custom button (drop-down style) to the custom toolbar. If the custom button is selected from the toolbar or menu bar, the previous configuration of the extension is retrieved from the registry, and a dialog box with the configuration is displayed. If the “Apply” or “OK” button in the dialog box is selected, then user entries are saved to the system registry. If the communication initiator 21 is enabled, then a timer is configured for the selected interval.

In another embodiment implemented using OUTLOOK 98, the add-in initiates an instance of another COM object, the EXCHANGE callback (IexchExt). The IexchExt::Install method is used to add the custom button to the Menu/Tools drop-down list. As it has been found that OUTLOOK 98 may cause buttons installed in this manner to disappear in some views, an instance of the OUTLOOK extension callback object (IoutlookExtCallback), is used. A method is added to IoutlookExtCallback::CommandBars to add a custom toolbar. A method is added to IoutlookExtCallback::Controls to add the button to the toolbar. The IexchExtUserEvents::OnSelectionChange method is used to trap mouse click events, and upon a mouse event, testing to see if the custom button is the location of the mouse event, with the appropriate display of a “pushed” button (on mouse click), or the dialog box (upon mouse release), as appropriate.

The communication initiator 21 initiates a communications session between the MAPI client 22 and the MAPI server 10 such that communication between the MAPI client 22 and the MAPI server 10 takes place. In one embodiment, the communication initiator 21 is implemented in a software subroutine that is incorporated into the extension. In an implementation specifically for a MICROSOFT OUTLOOK extension, the communication initiator 21 calls the OUTLOOK Inbox folder's “GetLast” Item method. This GetLast Item method establishes a communication session with minimal amount of network traffic. Sample VISUAL BASIC programming instructions that can be used to establish the communication session using the GetLast Item method are shown in TABLE 3.

TABLE 3
COMMUNICATION INITIATOR

Dim NS As Outlook.NameSpace
Dim Folder As Outlook.MAPIFolder
Dim Item as Outlook.MailItem
. . .
Set NS = Application.GetNamespace(“MAPI”)
Set Folder = NS.GetDefaultFolder(olFolderInbox)
Set Item = Folder.Items.GetLast

As shown in TABLE 3, the variable NS is assigned the result of the GetNamespace method. The variable Folder is assigned the result of the GetDefaultFolder method for the namespace in variable NS. Then, the variable Item is assigned the result of the GetLast method for the folder in variable Folder. The use of the GetLast method for the Inbox folder initiates the communications session between the MAPI client 22 and the MAPI server 10. Other methods that cause the MAPI client 22 to open a session with the MAPI server 10 can also be used.

The code shown in TABLE 3 can be called periodically, for example every 30 seconds, every minute, and so on, to periodically initiate a communications session. In one embodiment, a timer is used in the communication initiator 21 to periodically execute these instructions. It also may be useful to include error-handling functionality, in case unexpected results are returned by the code in TABLE 3.

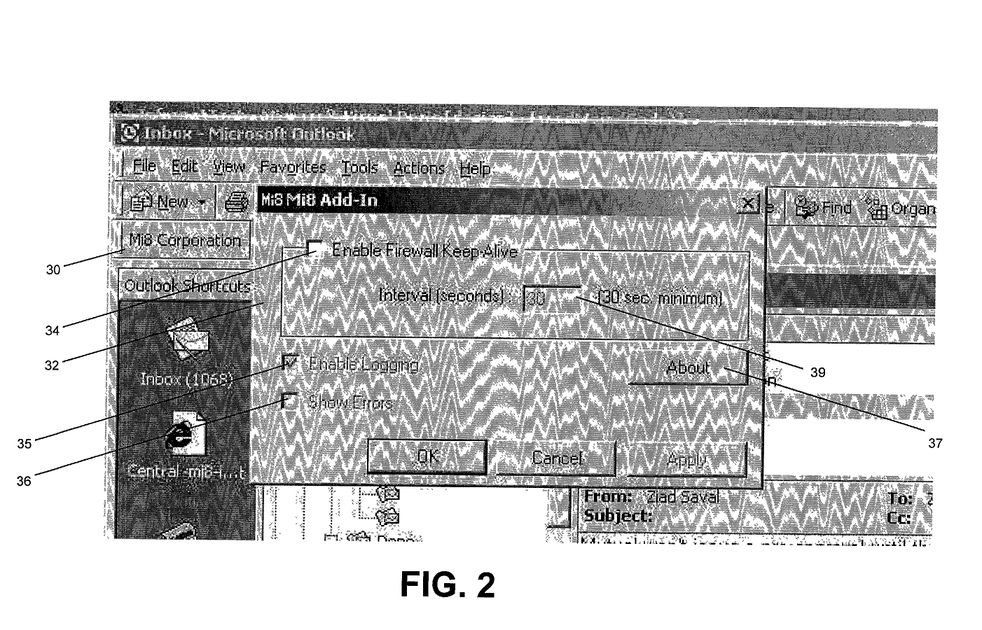

Referring to FIG. 2, in one embodiment in which MICROSOFT OUTLOOK is the -MAPI client, the interface code installs an additional menu item 30 onto the MAPI client display. As shown in the example, the additional menu item 30 is a toolbar button. In the implementation shown, the button says (“Mi8 Corporation”), but the text on the button could show other text or graphics in other implementations. The menu item could in other embodiments be implemented as a choice on a menu, such as a menu selection on the Tools menu, or a button or icon located elsewhere on the display. A special key sequence can also be used to activate the extension.

In the implementation shown, if the user clicks on the toolbar button labeled “Mi8 Corporation” 30, the “Mi8 Add-In” dialog box 32 is shown. In the dialog box 32, the user can enable or disable the communication initiator functionality by clicking on the check-box 34 that is labeled “Enable Firewall Keep-Alive.” If the check-box 34 is selected, the communication initiator functionality is enabled, and the user can set the time period 39 for periodically repeated communications session initiation. The period is labeled “Interval (seconds)” in the figure. In this implementation, 30 seconds is the minimum period for repeated communications session initiation. Also available for user action on the dialog box 32 is a check-box to enable logging 35 and a check box to show errors 36, to help debug operational problems with the extension with a particular user configuration. An About button 37 is also available to provide information to the user about the add-in.

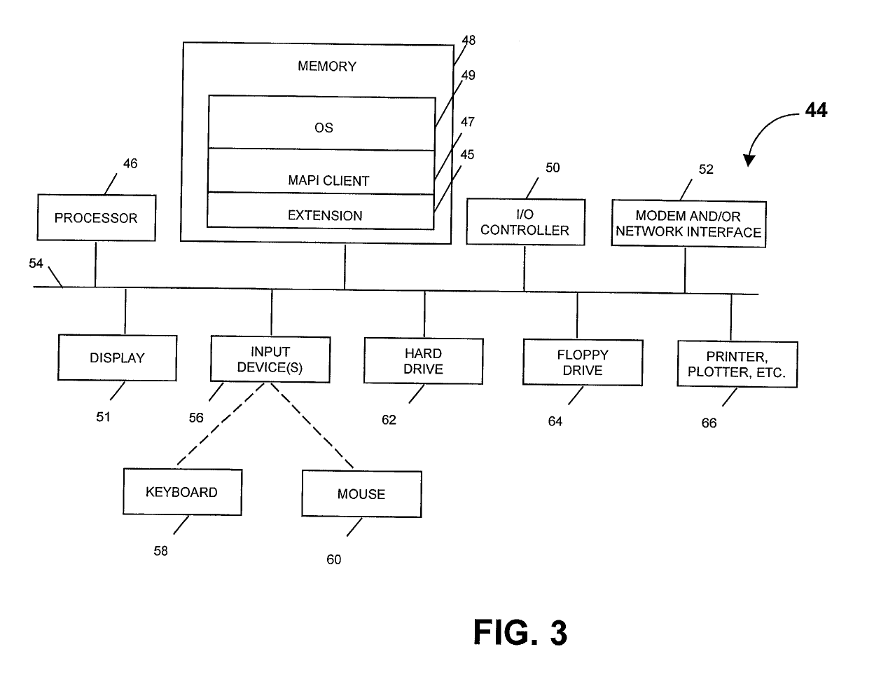

Referring to FIG. 3, in one embodiment a network node including a MAPI client is a general purpose computer including a central processor 46, a memory unit 48 for storing programs and/or data, an input/output (I/O) controller 50, a display device 51, and a data bus 54 coupling these components to allow communication between them. The memory 48 generally includes random access memory (RAM) and read only memory (ROM) chips. The computer 44 typically also has one or more input devices 56 such as a keyboard 58, and a mouse 60. The computer typically also has a hard drive 62 with hard disks therein and a floppy drive 64 for receiving floppy disks such as 3.5 inch disks. The computer also typically has a one or more data communications interfaces 52 to allow communication with other computers, such as a modem, an ethernet card, or other network interface. Such connection to an IP network involves static or dynamic assignment of an IP address to the network interface. The IP address may be a private network address as described above. Other devices also can be part of the computer 44 including output devices 66 (e.g., printer or plotter) and/or optical disk drives for receiving and reading digital data on a CD-ROM. These devices may be connected directly to the bus 54 as shown, or may be connected via parallel and serial ports.

One or more software programs 47, 49 define the operational capabilities of the computer 44. These software programs are typically loaded from one or more of the hard drive 62, the floppy drive 64, and the data communications interface 52, into the memory 48 of the computer. These software programs, as shown, include operating system (“OS”) 49, which may be such operating systems as MICROSOFT WINDOWS 98 or MICROSOFT WINDOWS NT, available from Microsoft Corporation of Redmond, Wash. These software programs also include a MAPI client 47, which, as described above, may be a MICROSOFT OFFICE software program, such as MICROSOFT OUTLOOK, also available from Microsoft Corporation. An extension 45 is added to the MAPI client to perform the interface and communication initiation functionality as described above.

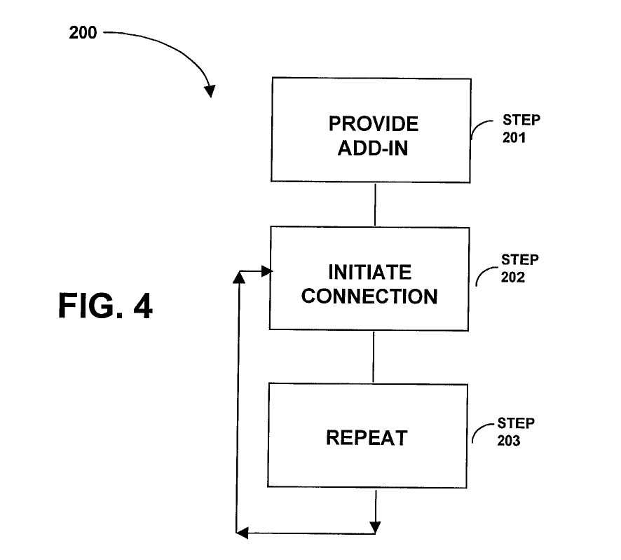

Referring to FIG. 4, a method 200 for extending a Messaging Application Programming Interface (MAPI) client for operation with a MAPI server across a network includes providing an extension to the MAPI client (STEP 201). In one embodiment, the extension is as described above, and is installed into the MAPI client so that it is integrated with the MAPI client. In one embodiment, the MAPI client is a MICROSOFT OFFICE software application. In one such embodiment, the MAPI client is MICROSOFT OUTLOOK. In one embodiment, the network includes a NAT or PAT gateway implementing network address translation. In another embodiment, the network includes a firewall. In one such embodiment, the NAT gateway is a firewall.

The method includes the step of initiating by the extension a communications session from the MAPI client to the MAPI server (STEP 202), such that the communications session allows for communication between the MAPI client and the MAPI server. In one embodiment, the communication includes notification of new electronic mail messages. In another embodiment, the communication includes communication of new electronic mail messages.

The method also includes repeating the initiating step (STEP 202) so that a communications session is repeatedly initiated (STEP 203). In one embodiment, a communications session is initiated periodically. In one such embodiment, a communications -session is periodically initiated at a predetermined time interval.

In one embodiment, the method also includes facilitating configuration of the predetermined time interval by a user of the MAPI client via a user interface. In one such embodiment, the user interface is as described with reference to FIG. 2.

Variations, modifications, and other implementations of what is described herein will occur to those of ordinary skill in the art without departing from the spirit and the scope of the invention as claimed. Accordingly, the invention is to be defined not by the preceding illustrative description but instead by the spirit and scope of the following claims.

What is claimed is:

1. An extension for extending a Messaging Application Programming Interface (MAPI) client for operation with a MAPI server across a network, comprising:
an interface for integrating with the MAPI client; and
a communication initiator for causing the MAPI client to initiate a communications session from the MAPI client to the MAPI server, wherein the communications session allows for communication between the MAPI client and the MAPI server.

2. The extension of claim 1 wherein the communication between the MAPI client and the MAPI server comprises notification of new electronic mail messages.

3. The extension of claim 1 wherein the communication between the MAPI client and the MAPI server comprises communication of new electronic mail messages.

4. The extension of claim 1 wherein the communication between the MAPI client and the MAPI server comprises communication of at least one of calendar items, task items, information about calendar items, information about task items, or some combination.

5. The extension of claim 1 wherein the initiator initiates the communications session upon the occurrence on an event.

6. The extension of claim 5 wherein the event comprises a mouse movement.

7. The extension of claim 6 wherein the event comprises selection of a menu item.

8. The extension of claim 1 wherein the initiator periodically initiates a communications session.

9. The extension of claim 8 wherein the initiator comprises a timer for periodically initiating a communications session.

10. The extension of claim 9 wherein the initiator comprises a timer for periodically initiating a communications session at a predetermined time interval.

11. The extension of claim 10 further comprising a user interface for facilitating configuration of the predetermined time interval by a user of the MAPI client.

12. The extension of claim 1 wherein the MAPI client comprises a MICROSOFT OFFICE software application.

13. The extension of claim 12 wherein the MAPI client comprises MICROSOFT OUTLOOK.

14. The extension of claim 13 wherein the MAPI server comprises MICROSOFT EXCHANGE.

15. The extension of claim 1 wherein the MAPI server comprises MICROSOFT EXCHANGE.

16. The extension of claim 1 wherein the network comprises a gateway located between a first network and a second network, and wherein the gateway implements at least one of network address translation (NAT) and port address translation (PAT).

17. The extension of claim 1 wherein the network comprises a gateway connecting a first network and a second network, and wherein the server is in communication with the first network and wherein the client is in communication with the second network, and wherein the gateway prevents communication initiation from the server to the client.

18. The extension of claim 1 wherein the gateway comprises a firewall.

19. A method for extending a Messaging Application Programming Interface (MAPI) client for operation with a MAPI server across a network, comprising the steps of:
providing an extension to the MAPI client; and
initiating by the extension a communications session from the MAPI client to the MAPI server, wherein the communications session allows for communication between the MAPI client and the MAPI server.

20. The method of claim 19 wherein the communications session is initiated repeatedly by the extension.

21. The method of claim 19 wherein the communication between the MAPI client and the MAPI server comprises notification of new electronic mail messages.

22. The method of claim 19 wherein the communication between the MAPI client and the MAPI server comprises communication of new electronic mail messages.

23. The method of claim 19 wherein the communication between the MAPI client and the MAPI server comprises communication of at least one of calendar items, task items, information about calendar items, information about task items, or some combination.

24. The method of claim 19 wherein the step of initiating is performed in response to the occurrence of an event.

25. The method of claim 24 wherein the event comprises a mouse movement.

26. The method of claim 24 wherein the event comprises selection of a menu item.

27. The method of claim 19 wherein the step of initiating is performed periodically.

28. The method of claim 27 wherein the step of initiating is performed periodically at a predetermined time interval.

29. The method of claim 28, further comprising the step of facilitating configuration of the predetermined time interval by a user of the MAPI client via a user interface.

30. The method of claim 19 wherein the MAPI client comprises a MICROSOFT OFFICE software application.

31. The method of claim 30 wherein the MAPI client comprises MICROSOFT OUTLOOK.

32. The method of claim 31 wherein the MAPI server comprises MICROSOFT EXCHANGE.

33. The method of claim 19 wherein the MAPI server comprises MICROSOFT EXCHANGE.

34. The method of claim 19 wherein the network comprises a gateway connecting a first network and a second network, and wherein the gateway implements at least one of network address translation (NAT) and port address translation (PAT).

35. The method of claim 19 wherein the network comprises a gateway connecting a first network and a second network, and wherein the server is in communication with the first network and wherein the client is in communication with the second network, and wherein the gateway prevents communication initiation from the server to the client.

36. The method of claim 35 wherein the gateway comprises a firewall.

37. An extension for extending an electronic mail client application running on a computer connected to a first network for operation with a electronic mail server running on a computer connected to a second network, the network comprising a gateway connecting the first network and the second network, wherein the gateway prevents notification of new electronic mail messages from the electronic mail server to the electronic mail client, comprising:
an electronic mail client application interface subsystem for integrating with the electronic mail client; and
a communication initiation subsystem for causing the electronic mail client to initiate a communications session from the electronic mail client to the electronic mail server, wherein the communications session allows for information relating to new electronic mail messages received at the server to be communicated from the electronic mail server to the electronic mail client.
